(19) United States
(12) Patent Application Publication
(10) Pub. No.: US 2010/0242104 A1
(43) Pub. Date: Sep. 23, 2010

(54) METHODS AND SYSTEMS FOR SECURE AUTHENTICATION

(76) Inventors: John R. Wankmueller, Great Neck, NY (US); Arthur D. Kranzley, Pound Ridge, NY (US)

Correspondence Address: BUCKLEY, MASCHOFF & TALWALKAR LLC, 50 LOCUST AVENUE, NEW CANAAN, CT, 06840, US

(21) Appl. No.: 12/501,701

(22) Filed: Jul. 13, 2009

Related U.S. Application Data
(60) Provisional application No. 61/162,617, filed on Mar. 23, 2009.

(51) Int. Cl. H04L 9/32; G06F 21/00

(52) U.S. Cl. 726/9

(57) ABSTRACT

A system, device, method, program instructions, and means for securely authenticating a user, the method including mapping, by a one time code generating device in the possession of a user, a one time code onto a graphical representation of a positional array; displaying the one time code mapped onto the graphical representation of the positional array; determining an encoded personal identification number (PIN), the encoded PIN is based on the one time code mapped onto the graphical representation of the positional array and a static PIN known by the user; and authenticating the user based on the encoded PIN.

### CROSS-REFERENCE TO RELATED APPLICATIONS

This application claims benefit of U.S. provisional patent application No. 61/162,617, filed Mar. 23, 2009, which application is incorporated herein by reference.

### BACKGROUND

As the use of and reliance on electronic commerce and electronic transactions by consumers and businesses continues to increase, there exists an ever-increasing need for securely authenticating such electronic commerce and other card not present transaction environments. As used herein, a card not present transaction refers to a card payment transaction in which the card is not in the same physical location as the merchant, wherein the merchant has to rely on the card holder to present the card information to them indirectly, such as over the Internet or by telephone. The present invention provides a mechanism for verifying the person presenting the card information for payment is indeed an authorized holder of the card.

A number of methods and systems have been proposed to provide a secure authentication method, device, and/or system. However, many such prior systems are technically complicated and expensive to implement and maintain, require substantial education of potential end users of the systems and methods, and are not convenient or readily incorporated into typical electronic commerce or card not present transactions.

Applicants have recognized a need to provide secure authentication of a user for electronic commerce and other card not present transactions. Further, it is desirable to provide a secure authentication of a user by an apparatus, system, and method that may be efficiently implemented and easily used by authorized users.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, wherein:

FIG. 1 is a flow chart that illustrates, at a high level, an authentication strategy, in accordance with aspects herein;

FIG. 2 is a graphical representation of a positional array, including positional location identifiers, in accordance with some embodiments herein;

FIG. 3 is a graphical representation of a positional array including positional location identifiers and a one time code, in accordance with some embodiments herein;

FIG. 4 is a graphical representation of a positional array including the one time code of FIG. 3, in accordance with some embodiments herein;

FIG. 5 is another embodiment of a graphical representation of a positional array including positional location identifiers and a one time code, in accordance with some embodiments herein;

FIG. 6 is an embodiment of a graphical representation of a positional array including the one time code of FIG. 5, in accordance with some embodiments herein;

FIG. 7 is another embodiment still of a graphical representation of a positional array including positional location identifiers and a one time code, in accordance with some embodiments herein;

FIG. 8 is an embodiment of a graphical representation of a positional array including positional location identifiers and a one time code, in accordance with some embodiments herein;

FIG. 9 is an embodiment of a graphical representation of a positional array including positional location identifiers and a one time code comprising letters, in accordance with some embodiments herein;

FIG. 10 is yet another embodiment of a graphical representation of a positional array including positional location identifiers and a one time code, in accordance with some embodiments herein;

FIG. 11 is a diagram representation of a system that may be operated in connection with still other aspects herein; and

FIG. 12 is a depiction of an embodiment of a one time code (OTC) device, in accordance with some embodiments herein.

### DETAILED DESCRIPTION

In general, and for the purpose of introducing concepts of embodiments of the present invention, a “two-factor authentication” method and system verifies two types of information to authenticate a user. Two-factor authentication, as used herein, refers to a system, method, device, or mechanism that verifies the user has personal knowledge of a specific item, that is, “something you know” and also verifies the user has possession of something, that is “something you have”. The personal knowledge factor may include a password or a PIN assigned or otherwise associated with the user and the personal possession factor may be satisfied by proof the user actually has a device such as an authenticator device personally in their possession. The use of two-factor authentication provides greater and more reliable security than an authentication process that requires only one of personal knowledge (PIN or other code) or personal possession of an item (payment card or other device or coded message).

Devices such as onetime password/code devices (OTC), whether implemented as tokens, key-fobs, cards sized similar to conventional payment cards, smart card readers/sleeves, or other configurations may be sent by businesses, financial institutions, banks, or other entities wishing to conduct secure transactions with their consumers, customers, or generally, users. The secure transactions may include commercial transactions such as purchase and sale transactions, financially sensitive transactions, the access to or exchange of data or other protected resources, and other transactions where access is to be provided only to an authenticated, authorized user.

In general, an OTC device may be issued to a user for the user's personal use. In some instances, the OTC device may be implemented as a key-fob, card, or card-shaped device that includes a memory and a CPU to generate “one-time passwords/codes” based on a secret key known to the OTC device. The key or algorithm used to generate the OTC by the OTC device is also known by an authenticator. The authenticator may be a person, system, or device and may be implemented as software, hardware, or a combination of software and hardware components. In some instances, a protected service or resource such as an online banking service, an online shopping service, or a business entity's private resource (e.g., network, server, library, etc.) may prompt the user for a passcode prior to allowing the user access to the protected service or resource. In some instances, the passcode may consist of a one-time password/code (i.e., OTC) obtained from the OTC device alone. In other instances, the passcode may consist of the OTC obtained from the OTC device and a personal PIN code associated with the user. Accordingly, in some situations the user may typically need to enter a four digit or longer PIN and also enter a 6-10 digit or longer) OTC for a passcode total length of 14 or more digits/characters. Entry of such long character strings are prone transcription and data entry errors by users.

Another problem with some authentication methods and systems results from entering a user's personal, static PIN into a data entry device (e.g., PC, ATM keypad or touch screen, etc.) “in the clear” or otherwise not encrypted, coded, or change from the original static PIN. Entry of the user's personal, static PIN in the clear may result in the user's personal PIN being compromised or otherwise captured by nearby onlookers and/or data entry capture devices (e.g., keystroke reader devices and/or programs). In an effort to introduce a level of security in instances where the PIN may be entered “in the clear”, a business, financial institution, or other entity may require Web pages (or other forms and channels of communication) used during an electronic communication session be secured by software and/or hardware solutions (e.g., using SSL sessions) to protect the consumer's static PIN. However, such additional security mechanisms add to the cost and complexity of the authentication system.

The present invention enables an end user, with an OTC generating device in their possession, the ability to securely provide to an entity with the ability to validate the generated OTC code, the additional ability to prove the end user indeed also knows the exact value of a shared static PIN code by sending a dynamic encoded PIN created according to embodiments and aspects disclosed herein.

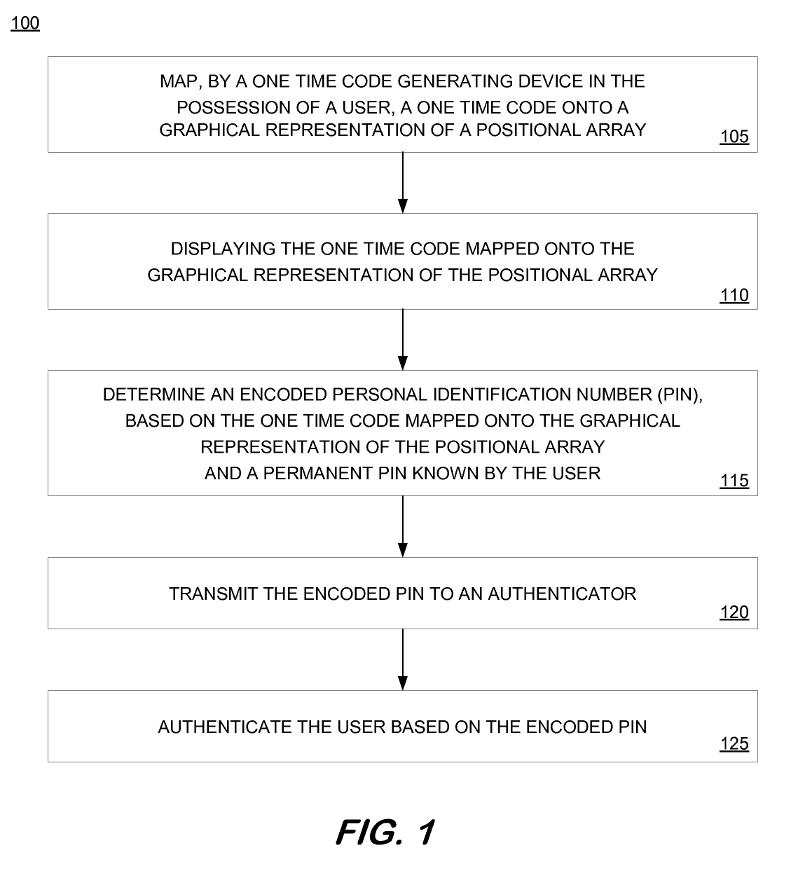

Features and embodiments of the present disclosure will now be described by first referring to FIG. 1 that is an exemplary flow diagram illustrating, at a high level, an authentication process 100, in accordance with aspects herein.

Process 100 may be performed by a system including an OTC device that generates and displays an OTC to a user in possession of the OTC device and a data entry device the user uses to enter a passcode based on the OTC displayed by the OTC device. At operation 105, an OTC generated by the OTC device is mapped onto a graphical representation of a positional array. Further detail regarding the composition and determination of the passcode, the OTC device, and the data entry device to receive the passcode will be provided below. In particular, the methodology for mapping the OTC onto the graphical positional array will be discussed in detail below.

In accordance with some embodiments and aspects herein, the OTC generated by the OTC device may be a string of any length of numbers, letters, or other alphanumeric characters. In some embodiments, the OTC comprises a string of 10 numbers or alphabetic characters which provides for secure two-factor authentication of the user. However, it is further noted that the length of the string of characters comprising the OTC may contain more than or fewer than 10 numbers or alphabetic characters.

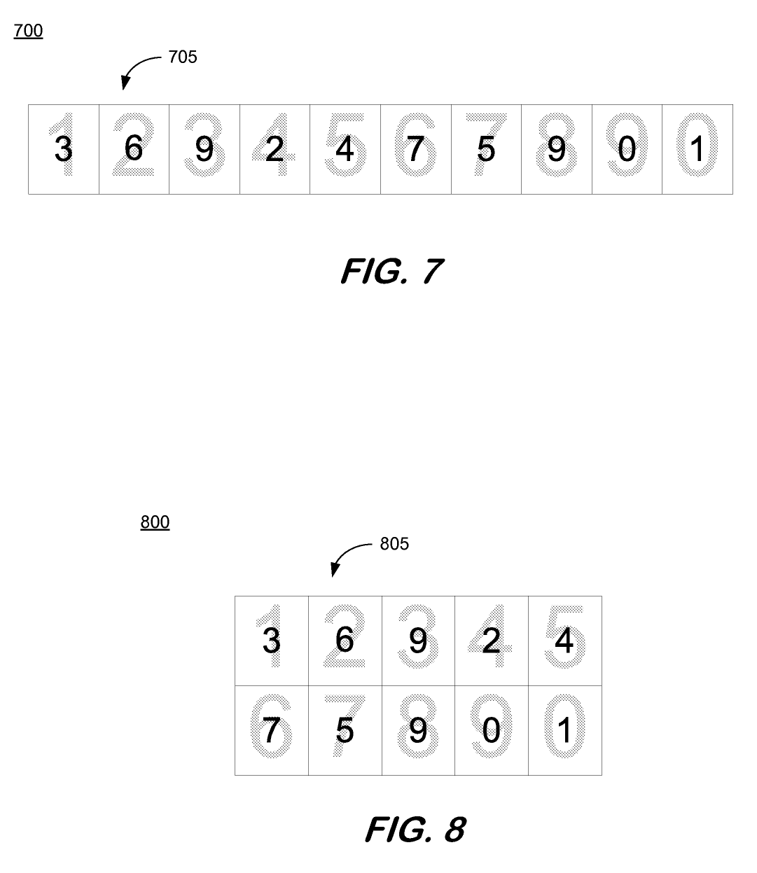

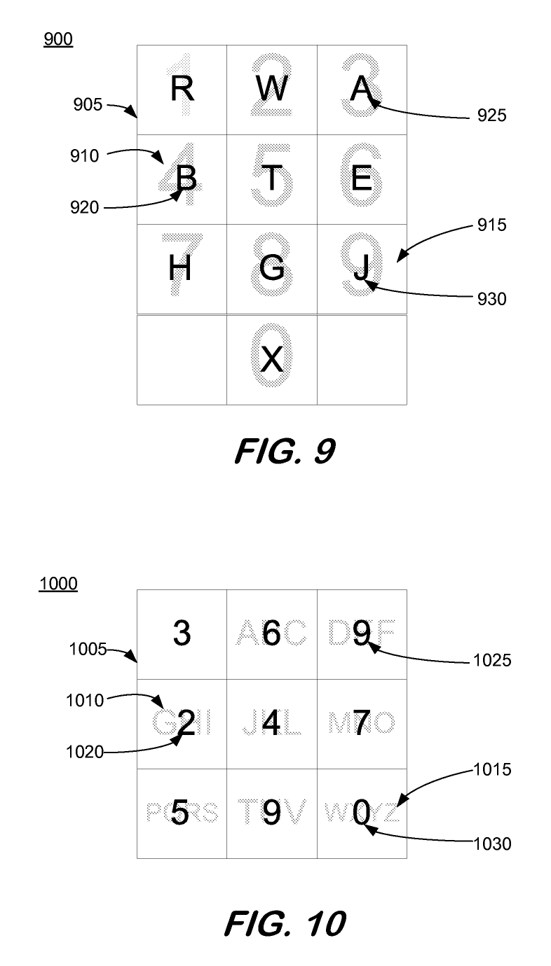

At operation 110, the OTC generated by the OTC device and mapped onto the graphical representation of the positional array is displayed by the OTC device. In accordance herewith, the mapped OTC may be presented in a wide variety of configurations and arrangements for viewing by the user. In some embodiments, the mapped OTC may be presented in a configuration and arrangement that is easily viewed and recognizable to a user. For example, the OTC may be mapped onto the graphical representation of the positional array configured as a telephone keypad (e.g., FIGS. 1-6, 9, and 10), a one dimensional array with five positions (e.g., FIG. 7), two one dimensional arrays of five positions each, one on top of the other (e.g., FIG. 8), a telephone keypad with alphabetic OTC characters instead of numeric OTC characters (e.g., FIG. 9).

In some embodiments, such as those in which the graphical representation of the positional array onto which the OTC is mapped may be configured in a manner visually familiar to potential users, a string of characters may be sent, transmitted, or otherwise provided at or to the OTC device. In some embodiments, for example, a mobile phone or other device may receive a SMS (Short Message Service) message or other type of message with dynamic mapping instructions such as “Your PIN digit 1=E, 2=B, 3=R, 4=V etc.”.The message including the dynamic mapping instructions may be sent to the OTC device by the mobile phone service provider or a third party.

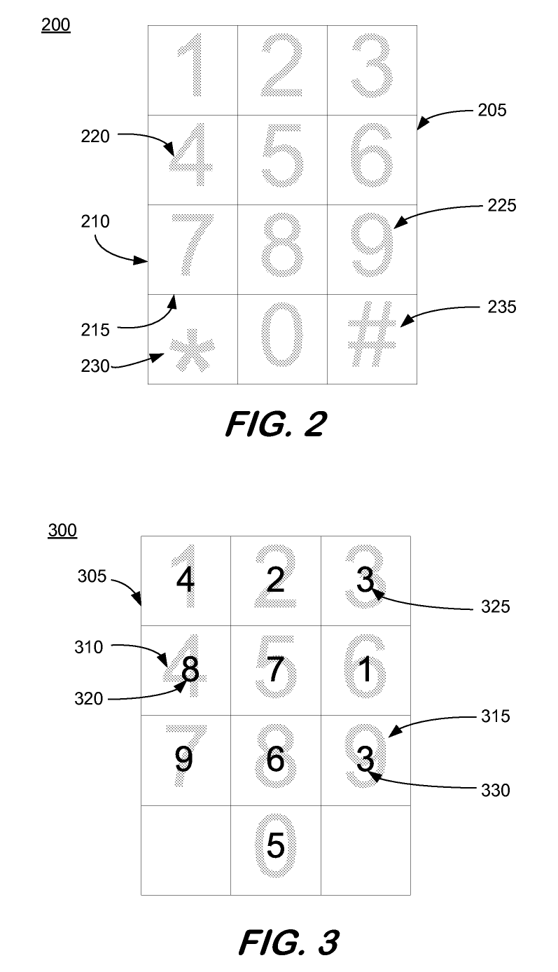

Referring to FIG. 2, a display 200 of a graphical representation of a positional array 205 onto which an OTC may be mapped is illustrated. Positional array 205 is configured in an arrangement similar to a numeric keypad that may be provided on a phone, a computer keyboard, ATM, calculator, point of sale (POS) device, and other like devices. Positional array 205 is defined by a number of intersecting vertical lines 210 and horizontal lines 215. In some embodiments, not all of the intersecting vertical and horizontal lines shown in FIG. 2 need be or are necessarily displayed. Each position location in positional array 205 is identified by location identifiers. In the present example, the location identifiers include the ten digits 0-9, as well as the “*” and “#” symbols. In some other embodiments, each position location in positional array 205 may be identified by location identifiers that include letters or other alphanumerics. In some embodiments, none or only some of the position locations in a positional array may be identified by location identifiers.

Positional array 205 includes numbers acting as position location identifiers. The position location identifiers include the ten digits 0-9 (e.g., 220, 225), “*” symbol 230, and “#” symbol 235, arranged in a manner similar to, for example, a phone keypad.

FIG. 3 is an illustrative example of a display 300 of an OTC device presenting a positional array 305 with an OTC mapped onto the positional array. In particular, positional array 305 including position location identifiers (e.g., 310, 315) has the OTC “4 2 3 8 7 1 9 6 3 5” (e.g., OTC digits 320, 325, 330) mapped onto the positional array.

In an effort to provide clear and concise drawings, not all of the position location identifiers and OTC digits depicted in FIG. 3 and other drawings herein are individually labeled by reference numbers. However, that which comprises the position location identifiers and OTC digits herein should be clearly understood by the representative position location identifiers and OTC digits depicted that are labeled by reference numbers.

In some embodiments, the OTC mapped onto a positional array may be presented in a format contrasting with the position location identifiers of the positional array. For example, the OTC of FIG. 3 is represented on positional array 305 by digits (e.g., 320, 325, 330) presented in a darker or bolder format as compared to the positional location identifiers (e.g., 310, 315).

It should be appreciated that in some embodiments, that either the OTC or the position location identifiers may be emphasized or de-emphasized, relative to each other. In other embodiments still, neither the OTC nor the position location identifiers may be emphasized or de-emphasized relative to the other. The emphasis or de-emphasis of the OTC and the position location identifiers may be accomplished by variances in relative size, shading, highlighting, coloring, permanence of the OTC and position location identifiers, and other attributes, including combinations thereof.

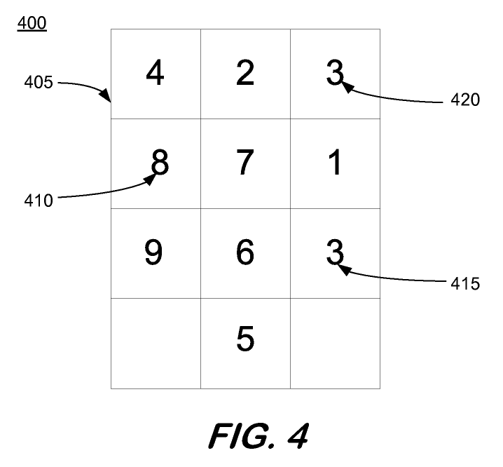

In some embodiments, such as the FIG. 4 display 400 of an OTC device graphically presenting a positional array 405 with an OTC mapped onto the positional array, there are no position location identifiers for the position locations of the positional array present in the display. Instead, only the OTC “4 2 3 8 7 1 9 6 3 5” (e.g., 410, 415, and 420) is presented, whereas no position location identifiers are provided. Thus, in some embodiments, a user may not have or need the visual cues provided by the position location identifiers (of FIG. 3 for example) since the configuration and layout of the positional array 405 is consistent with a phone keypad. Additionally, the user need not actively memorize the position location identifiers (of FIG. 3 for example) since the configuration and layout of the positional array 405 is consistent with a phone keypad and thus familiar to the user.

Returning to the flow diagram of FIG. 1, authentication process 100 proceeds to operation 115 wherein a dynamic or encoded PIN is determined. The encoded PIN is determined based on the OTC mapped onto the graphical representation of the positional array and a permanent or static PIN known and associated with the user being authenticated. This operation may be further understood by an example referencing FIGS. 3 and 4 where the OTC “4 2 3 8 7 1 9 6 3 5” is mapped onto the positional array (305, 405). In the instance the user's personal, static PIN is “5012”, the corresponding encoded or dynamic PIN based on the OTC mapped onto the graphical representation of the positional array and permanent or static PIN is “7542”. In particular, the digits of the static, personal PIN “5012” relate one-to-one (1:1) to the encoded PIN “7542” due to the mapping of the OTC onto the positional array 305, 405. The encoded PIN “7542” corresponds to the OTC digit value mapped onto the corresponding static, personal PIN “5012” position location of the positional array.

Advantageously, since the personal PIN relates one-to-one (1:1) to the encoded PIN due to the mapping of the OTC onto the positional array, a user of the methods and systems herein may easily and readily determine an encoded PIN based on a display of an OTC mapped onto the graphical representation of a positional array without having to memorize or learn any information in addition to the personal, static PIN already associated with and known by the user. Since methods and systems herein use the user's static, personal PIN, there is no need to generate and/or track multiple PINs by a device, system, administrator, or authenticator, and the user need not memorize, learn, or keep track of multiple PINs or other codes or passwords.

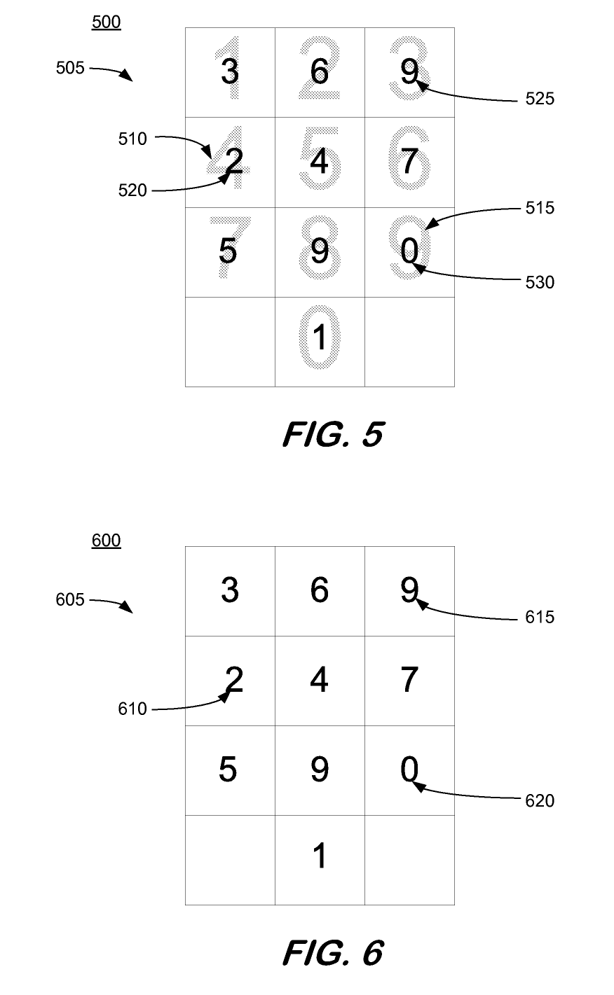

FIGS. 5 and 6 relate to another example of determining an encoded PIN that is determined based on an OTC mapped onto a graphical representation of a positional array and permanent or static PIN known to and associated with the user being authenticated, in accordance with some aspects herein. In the example of FIGS. 5 and 6, the OTC “3 6 9 2 4 7 5 9 0 1” is mapped onto the positional array (505, 605). In the instance the user's personal, static PIN is “7154”, the corresponding encoded or dynamic PIN is “5342” based on the OTC mapped onto the graphical representation of the positional array and permanent or static PIN. In particular, the digits of the static, personal PIN “7154” corresponding to OTC digits mapped onto the positional array relate on a one-to-one (1:1) basis with the encoded dynamic PIN of “5342” is due to the mapping of the OTC onto the positional array 505, 605. The encoded PIN “5342” corresponds to the positional locations of the OTC mapped onto the positional array.

FIGS. 7 and 8 also include examples, in accordance with some embodiments, of an output (700, 800) of an OTC device graphically presenting a positional array 705, 805 with an OTC mapped onto the positional array. Both displays 700 and 800 include numeric position location identifiers for the position locations of the positional array 705, 805, respectively. The OTC for FIGS. 7 and 8 is also “4 2 3 8 7 1 9 6 3 5”. Since both FIGS. 7 and 8 have the same OTC numerics as the examples of FIGS. 5 and 6, the dynamic encoded PIN for FIGS. 7 and 8 is also “5342”, which corresponds to the positional locations of the OTC mapped onto the positional array but presented in a different visual format.

FIG. 9 relates to an example of an encoded PIN that is determined based on an OTC mapped onto a graphical representation of a positional array and a static PIN known to and associated with the user being authenticated, in accordance with some embodiments herein. In the example of FIG. 9 a permanent or static PIN of “7154 would correspond or map to a dynamic “alpha” PIN code of HRTB. Using an alpha dynamic PIN may lessen potential user mapping errors since the user maps their numeric PIN digits to OTC alphabetic, not other numeric, characters.

Based on the static PIN and the OTC used to determine the encoded PIN, the user may enter or provide the encoded PIN (numeric or alpha) to the requestor without fear of revealing their static PIN since the OTC code changes every time of use and the corresponding mapped dynamic PIN changes every time of use. A back end authenticator may then verify the user is both in possession of the OTC generating device and that the end user knows the shared static PIN value in the instance the mapping of the static PIN over the dynamic OTC code is correct.

Referring to FIG. 1 at operation 120, the encoded PIN may be transmitted or provided to an authenticator that will verify whether the user is authentic or otherwise authorized to complete a transaction or gain access to a transaction or resource protected by an authentication process in accordance with aspects herein at operation 125. The encoded PIN may be transmitted to the authenticator by a number and variety of methods in accordance herewith. For example, the user may provide the encoded PIN in reply to a prompt or request by a person or automated voice prompt over a telephone, in reply to prompt or request by a banking, financial, or electronic commerce system in an online banking or commerce context, in reply to a prompt or request to an electronic accessible system or resource, or other systems and devices. The communication channel and format may vary without altering other aspects herein. For example, the encoded PIN may be transmitted using any one of a variety of wired or wireless communication channels, protocols, and techniques.

In some embodiments, the encoded or dynamic PIN may be received by a device, system, or apparatus via input of one or more of a variety and type of data entry devices and mechanisms. For example, the user may enter an encoded PIN into a system, device, or apparatus using a keyboard, numeric keypad, microphone, or other input/output (I/O) device capable of facilitating the user's entry of the encoded PIN. For example, in the instance the user is prompted by a Web page accessed by a PC used by the user to provide an encoded PIN determined accordance with aspects herein, the user may enter the encoded PIN using a keyboard, numeric keypad, mouse (i.e., point and click), touch screen, touch pad, microphone, etc. interfaced with the PC and operating as an I/O device for the PC.

This invention provides a means to very securely send a user's PIN over a network to a back end verifier (i.e., authenticator) without the need to encrypt the channel and yet maintain the security of the user's static PIN.

In accordance with some aspects herein, a secure authentication technique is provided that ensures that a user's PIN is provided but not “in the clear”. In particular, while an encoded or dynamic PIN based on the user's static, personal PIN may be provided in the clear, the user's personal PIN is not provided in the clear or otherwise compromised wither at entry or by transmission of the static PIN in the clear. Therefore, the security of the user's personal, static PIN is not compromised by the systems and methods herein.

Furthermore, the authentication techniques and mechanisms herein provide two-factor authentication using OTC devices that may be less expensive than prior OTC devices. In some embodiments, an OTC device in accordance with some aspects herein need not have data entry capabilities. Also, in some embodiments, devices such as a mobile phone or other personal consumer electronic devices (e.g., digital music player, electronic organizer, watch, etc.) capable of executing an application, applet, program, code, or instructions embodying the methods and techniques herein may be used to implement an OTC device or method.

In general, embodiments utilize OTC devices (such as fobs, mobile phones, etc.) in conjunction with data entry devices (such as ATMs, personal computers, etc.) to allow a user to enter an encoded version of the user's static PIN. The encoded PIN may be based on a one-time code generated by the OTC device. A back-end authenticator or verifier (such as, for example, a payment card issuer) can deduce the user's static PIN by recreating the OTC code generated by the OTC device and verifying the mapping of the user's PIN to the positional array of OTC digits.

In accordance with some embodiments, FIG. 10 is an illustrative example of a display 1000 of an OTC device presenting a positional array 1005 with an OTC mapped onto the positional array. In particular, positional array 1005 includes position location identifiers (e.g., 1010,1015) that include the twenty-six letters (e.g., 1020, 1025, and 1230) of the modern English alphabet (i.e., A through Z). The letters may be arranged in the configuration shown or other configuration.

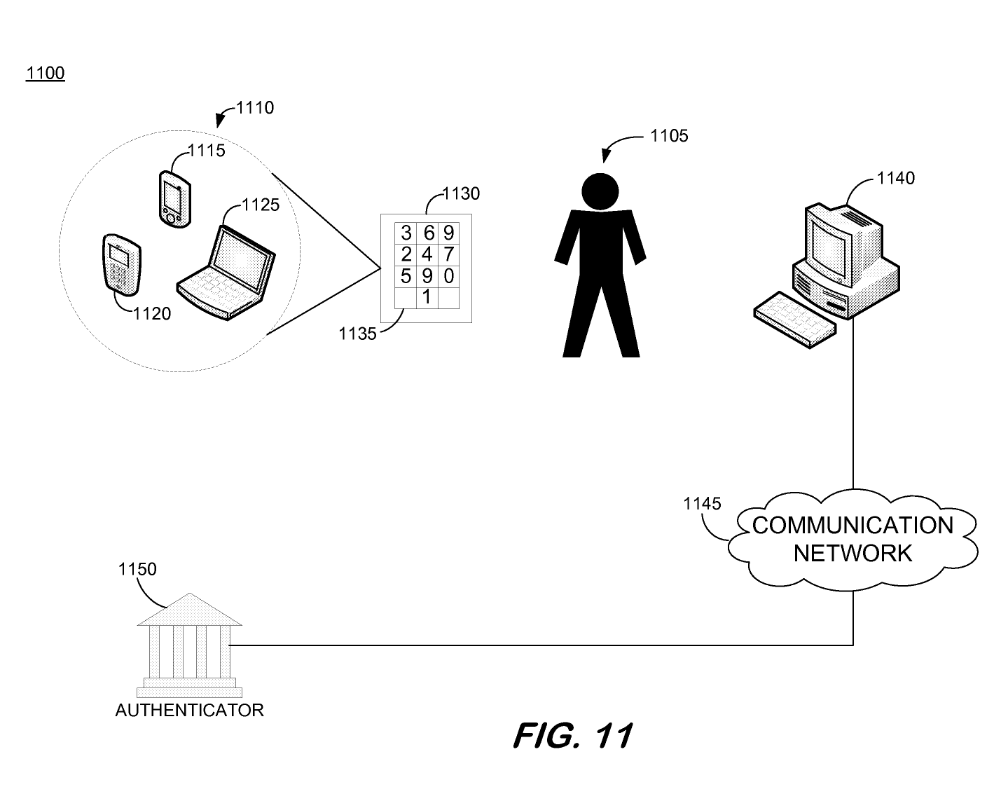

To further describe some features of some embodiments herein, an illustrative example will now be provided with reference to FIG. 11. In the illustrative example, a user 1105 wishes to securely access or login to her account using a PC 1140. User 1105 has an account at a financial institution, and the financial institution has implemented a two-factor authentication process using aspects of the present disclosure. In particular, the financial institution has provided user 1105 with an OTC device 1110 that generates one-time codes when requested by the user. The one-time codes may be generated using, for example, a secret key that is known to the financial institution or an agent of the financial institution and to the OTC device. Therefore, the financial institution or agent of the financial institution acting as an authenticator can recreate or verify the authenticity of any one-time code validly created by user 1105 in possession of OTC device 1110.

In this illustrative example, the OTC device may be a mobile phone 1120, a media player 1115, a laptop or netbook computer 1125, or another device having the functionality of an OTC device or having an application created, provided by or on behalf of the financial institution for use of an account owned by user 1105. The user may operate OTC device 1110 to authenticate her session at another device having data entry means and capable of communicating with the financial institution. In the present example, the other device is PC 1140. First, user 1105 begins her transaction at PC 1140 by, for example, providing her account number or other data needed to initiate an account logon via a web page associated with the financial institution. A Web page accessed via PC 1140 may prompt user 1105 to enter her PIN number. At this point, or even prior to providing the login information, the user may launch or interact with the OTC application on her mobile phone comprising OTC device 1110 to request a one-time code be generated for this particular interaction. OTC device 1110 may create, for example, a 10 digit OTC. As previously stated, other lengths and configurations of the OTC may be generated. OTC device 1110 displays the OTC mapped onto a graphical representation of a positional array as disclosed herein.

Pursuant to some embodiments, the one-time code is displayed to the user using graphical techniques that enable the user to quickly use the displayed information, as described herein with reference with FIGS. 1-9. In some embodiments, the one-time code is displayed to the user in the form of a graphical representation of a key pad positional array having 4 rows of 3 virtual keys. Pursuant to some embodiments, the individual digits of the OTC generated by OTC device 1110 are overlaid as digits on the graphical representation of the positional array key pad.

Upon display of the OTC mapped onto the graphical representation of the positional array, user 1105 may now determine an encoded PIN based on the mapped OTC and the user's static PIN. The user may then enter the encoded PIN based on the mapped OTC and the static PIN into PC1 140. PC 1140 may thereafter cause the dynamic, encoded PIN to be transmitted over communication network 1145 to the financial institution for authentication, i.e., authenticator 1150. The financial institution may receive the dynamic, encoded PIN and translate the encoded PIN into the user's static PIN by recreating the OTC using a shared secret key known to OTC device 1110 and the authenticator. In the instance the authenticator can correctly verify the user's static PIN from the encoded PIN received, the user is authenticated. Otherwise, the user is not authenticated.

Accordingly, system 1100 may provide a secure authentication technique that greatly increases transaction security without the need for costly or complex encryption and hardware or OTC devices that have their own input keys or need to securely store and maintain user PIN codes to be verified in the device. Embodiments may be used to provide reliable authentication of a wide variety of transactions, including financial services and other transactions.

Pursuant to some embodiments of the present invention, proof that the OTC device is present is provided since a user is able to generate a verifiable code using the OTC device, as well known in the art. The OTP device must be in the user's possession since the OTC codes generated for one time use or are one time codes valid for a very short time (e.g., 15, 30 or 60 seconds) if the device has an internal clock. Further, proof is provided that the user is also present since the user is required to use knowledge of their PIN to create a dynamic, encoded PIN.

In one embodiment, the device that generates the OTC (e.g., 1110) is different than the device (e.g., 1140) into which the user enters the encoded, dynamic PIN.

In some embodiments, a user may provide a first OTC value and then use a second or next OTC value generated by the OTC device to permute the PIN values, as disclosed herein. In some aspects, these particular embodiments may provide an enhanced level of security and proof that the user is in possession of the OTC device.

In some embodiments, for an OTC device that display 8 digits, a user may map their static PIN digits 0 or 1 to the first OTC array digit and for PIN digits 8 and 9, the user may map them to the last position of the OTC array digit. Ital

In some embodiments, such as the embodiment illustrated in FIG. 9, an OTC comprising alphabetic characters may be constrained to a limited set (or subset) of alphabetic characters. In some instances, the set of alphabetic characters may be limited so as to avoid confusion between alphabetic characters that may be commonly confused with other alphabetic characters when presented either visually (e.g., via a display screen) or spoken (e.g., presented to a user via an output). In some instances, the limited set of alphabetic characters may be limited to alphabetic characters that are not readily confused with letters (e.g., exclude upper and lower case letter “o”, lower case letter “b”, etc.). In some embodiments, the limited set of alphabetic characters may be limited to a set of alphabetic letters chosen or assigned to the user.

In some embodiments, where an encoded, dynamic PIN determined according to aspects herein, is to be entered into a device or system that accepts or otherwise expects numeric inputs, alphabetic letters comprising an OTC may be limited to a set of alphabetic characters that correspond to the expected numeric inputs of the device or system. Devices or systems that may accept or otherwise expect numeric inputs can include, for example, a device having a numeric only keypad, a touchscreen only displaying a numeric keypad, and a system having voice response unit system that expects a numeric reply from the user, and etc. As an example in the instance a device or system expects or accepts the ten numeric digits 0-9, the set of alphabetic characters that may comprise a possible OTC may be limited to a first (or other) grouping of ten letters of the alphabet (e.g., the letters A B C D E F G H J K), where the letter “I” is not used since it may be confused with the number 1. In this example, A=0, B=1, C=2, D=3, E=4, F=5, G=6, H=7, J=K. It is noted that other agreed upon or communicated alphabetic to number mapping arrangements may be used herein. In some embodiments, a brief explanation of the manner in which a user is to map an OTC (either numbers or alphabets) to a corresponding array of numbers of letters may be provided in advance of, concurrent with, or following the presentation of the OTC to the user. In some embodiments, the explanation of the OTC mapping method may be provided by the OTC device or by a separate device or method such as, for example, provided to the user in a mailing separate from the OTC device.

In some embodiments, an OTC herein may include duplicates of one or more characters comprising the OTC. For example, in some instances the OTC (3 3 3 4 5 6 6 6 7 8) may be valid, even though the numbers “3” and “6” are repeated multiple times.

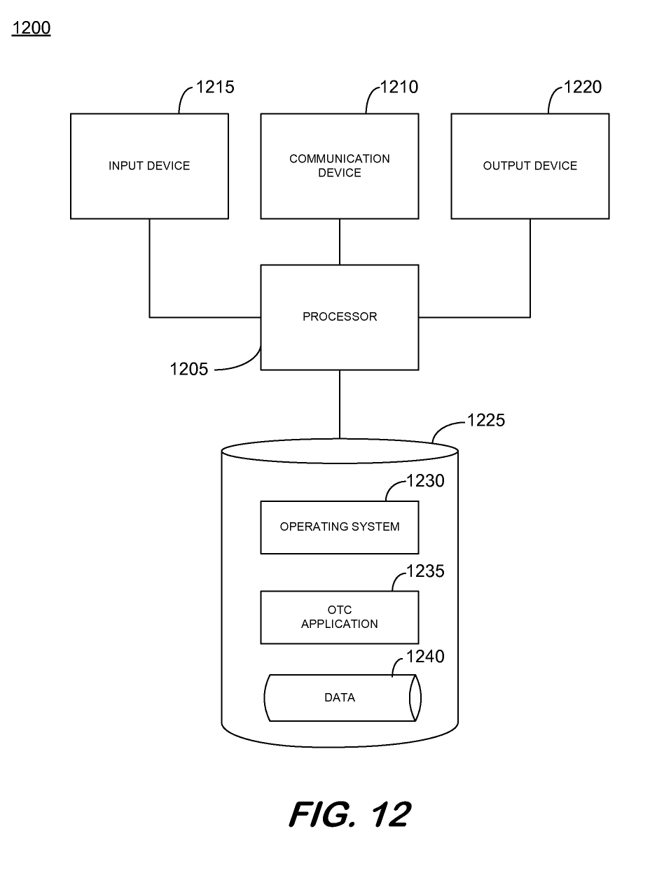

FIG. 12 is a block diagram representation of an OTC device, system, or apparatus 1200 that may be held in the possession of a user (e.g., 1105 of FIG. 11), in accordance with one or more of the embodiments herein. OTC device 1200 may be conventional in its hardware aspects but may be controlled by software (e.g., an application) to cause it to operate in accordance with aspects of the present invention.

OTC device 1200 may include a processor 1205 operatively coupled to a communication device 1210, a storage device 1225, an input device 1215, and an output device 1220. Processor 1205 may be constituted by one or more single or multi-core processors. Processor 1205 may operate to execute processor-executable steps, contained in program instructions, so as to control OTC device 1200 to provide a desired functionality.

It should be appreciated that OTC device 1200 is not limited to the particular configuration shown in FIG. 12 and may include fewer, more, substitute, or different components than those specifically depicted in FIG. 12, without departing from the scope of the present disclosure. For example, in some embodiments, OTC device may include a clock or clock functionality to facilitate the operation of OTC device 1200 (e.g., synchronization with other devices and systems).

Communication device 1210 may be used to facilitate communication with, for example, other devices (not shown). The communication with the other devices may be by a wired or wireless wired communication link, or a combination of both wired and wireless wired communication links. Likewise, the communication protocol used by OTC device 1200 may vary to facilitate communication over a variety of communication channels and networks.

Input device 1215 may comprise one or more of any type of peripheral device used to input data into a machine, computer, phone, or other device. For example, input device 1215 may include a keyboard, a keypad, a touchpad, a touch screen, a touchpad, a scroll-ball, a microphone, and a mouse. Output device 1220 may comprise one or more of any type of peripheral device used to output information from a machine, computer, phone, or other device. For example, output device 1220 may include a display screen, a monitor, a speaker, and a printer.

Storage device 1225 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, a solid state drive, as well as other so-called flash memory, whether fixed in OTC device 1200 or removable. Storage device 1225 may store one or more programs for controlling processor 1205. The programs may include program instructions that contain processor-executable process steps of computer system 1200, including, in some instances, process steps that constitute processes provided in accordance with principles of the present invention, as described in detail herein. The programs may include an operating system 1230 that allows OTC device 1200 to operate to generally control the functionality of the OTC device, including processor 1205, communication device 1210, input device 1215, and output device 1220. In some embodiments, OTC device may generally operate to provide the functionality of, for example, a mobile phone (e.g., 1120), a media player (e.g., 1115), a netbook (e.g., 1125), or another type of device.

Further, the programs stored on storage device 1225 may include an OTC application 1235 that operates to control the generation and provisioning of a presentation of an OTC at output device 1220 to a user in possession of the OTC device, in accordance with other aspects herein. In some embodiments, OTC application 1235 may be received or downloaded from a store, service provider, or supplier (not shown) “over the air” by OTC device 1200 for loading onto and execution by the OTC device. In some embodiments, commands, signals, or instructions regarding the determination of the OTC generated by OTC device 1200 and/or the timing thereof may be received “over the air”.

OTC device 1200 may also store data in a database 1240. Database 1240 may contain data concerning a general operation of OTC device and operation of OTC device to generate an OTC, in accordance with other aspects and methods herein. In some embodiments, records or logs of transactions regarding an OTC generated by OTC device 1200 may be stored in a separate database (not shown) that is apart from database 1240.

In some embodiments herein, an OTC device may provide dynamic mapping instructions to inform the user of the OTC code and the manner of mapping the OTC onto a positional array without providing a graphical representation of the positional array. As mentioned above, in some embodiments, the OTC device may include a mobile phone or other device capable of receiving a message. The message may include any number and variety of message types and formats capable of including, at least, text. For example, the message types may include an email, a SMS (Short Message Service) message, a MMS (Multimedia Messaging Service) message, an IM (Instant Message), a “social network” message, and other type of messages. In embodiments where the dynamic mapping instructions (e.g., “Your PIN digit 1=E, 2=B, 3=R, 4=V, . . . ”) are provided in or part of a message, the device operating as an OTC device may not have an “OTC” application, program, or instructions residing on or executed by the device. Instead, a device capable of receiving a message including the dynamic mapping instructions may operate as an OTC device in accordance with other aspects herein.

In some embodiments, a device capable of receiving and presenting messages that include graphical or multimedia content may function as an OTC device, in accordance with aspects herein. For example, a mobile phone, media player, or other device capable of receiving and presenting a message including a picture or a movie may present an OTC mapped onto a graphical representation of a positional array in the form of one or more pictures or movies. Likewise, a mobile phone, media player, or other device capable of receiving and presenting a message including music or voice content may present dynamic mapping instructions to the user in a spoken or song format (e.g., “Your PIN digit 1=E, 2=B, 3=R, 4=V, . . . ).

The above descriptions of processes herein should not be considered to imply a fixed order for performing the process steps or operations. Rather, the process steps may be performed in any order that is practicable, including simultaneous performance of at least some operations.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method for securely authenticating a user, the method comprising:
mapping, by a one time code generating device in the possession of a user, a one time code onto a graphical representation of a positional array;
displaying the one time code mapped onto the graphical representation of the positional array;
determining an encoded personal identification number (PIN), the encoded PIN is based on the one time code mapped onto the graphical representation of the positional array and a static PIN known by the user;
transmitting the encoded PIN to an authenticator; and
authenticating the user based on the encoded PIN.

2. The method of claim 1, wherein position locations of the positional array are indicated by at least one of numbers, letters, and a combination thereof.

3. The method of claim 2, wherein the position locations of the positional array indicated by at least one of numbers, letters, and a combination thereof are graphically displayed in combination with the one time code mapped onto the graphical representation of the positional array.

4. The method of claim 3, wherein the position locations of the positional array indicated by at least one of numbers, letters, and a combination thereof are graphically displayed in a format contrasting with the one time code mapped onto the graphical representation of the positional array.

5. The method of claim 1, further comprising generating the one time code by the one time code generating device.

6. The method of claim 1, wherein the mapping of the one time code onto a graphical representation of a position array includes sequentially associating the one time code with positional locations of the positional array.

7. The method of claim 1, wherein the encoded PIN differs from the static PIN known by the user.

8. The method of claim 1, wherein the authenticator authenticates the encoded PIN based on the authenticator's knowledge of a key used to generate the one time code.

9. The method of claim 1, wherein the user is not knowledgeable of a sequence, pattern, or methodology used for mapping the one time code onto the graphical representation of the positional array.

10. The method of claim 1, wherein the one time code generating device includes at least one of: a mobile phone, a card-shape device, a computer, a key-fob, any other device capable of displaying the one time code.

11. The method of claim 1, further comprising:
initiating a transaction requiring an authentication of the user; and
completing the transaction using the authentication of the user based on the encoded PIN.

12. The method of claim 1, wherein the transmitting of the encoded PIN is performed by a device other than the one time code generating device.

13. A computer-readable medium storing processor-executable instructions, that when executed by a processor perform a method, the computer-readable medium comprises:
instructions for mapping, by a one time code generating device in the possession of a user, a one time code onto a graphical representation of a positional array; and
instructions for displaying the one time code mapped onto the graphical representation of the positional array.

14. The computer-readable medium of claim 13, further comprising:
instructions for transmitting an encoded personal identification number (PIN) to an authenticator, the encoded PIN is based on the one time code mapped onto the graphical representation of the positional array and a static PIN known by the user; and
instructions for authenticating the user based on the encoded PIN.

15. The computer-readable medium of claim 13, wherein position locations of the positional array are indicated by at least one of numbers, letters, and a combination thereof.

16. The computer-readable medium of claim 15, wherein the position locations of the positional array indicated by at least one of numbers, letters, and a combination thereof are graphically displayed in combination with the one time code mapped onto the graphical representation of the positional array.

17. The computer-readable medium of claim 15, wherein the position locations of the positional array indicated by at least one of numbers, letters, and a combination thereof are graphically displayed in a format contrasting with the one time code mapped onto the graphical representation of the positional array.

18. The computer-readable medium of claim 13, further comprising instructions for generating the one time code by the one time code generating device.

19. The computer-readable medium of claim 13, wherein the authenticator authenticates the encoded PIN based on the authenticator's knowledge of a key used to generate the one time code.

20. The computer-readable medium of claim 13, wherein the transmitting of the encoded PIN is performed by a device other than the one time code generating device.

21. A device comprising:
a processor for generating and mapping a one time code onto a graphical representation of a positional array; and
a display for visually presenting the one time code mapped onto the graphical representation of the positional array.

22. The device of claim 21, wherein the mapping of the one time code onto a graphical representation of a position array includes sequentially associating the one time code with positional locations of the positional array.

23. The device of claim 21, wherein position locations of the positional array are indicated by at least one of numbers, letters, and a combination thereof graphically displayed in combination with the one time code mapped onto the graphical representation of the positional array.
